(19) United States
(12) Patent Application Publication
(10) Pub. No.: US 2025/0066544 A1
(43) Pub. Date: Feb. 27, 2025

(54) AN AMINO ACID BASED BIODEGRADABLE, PHOTOCURABLE COMPOSITION FOR 3D PRINTING APPLICATION

(71) Applicant: COUNCIL OF SCIENTIFIC AND INDUSTRIAL RESEARCH (AN INDIAN REGISTERED BODY INCORPORATED UNDER THE, New Delhi (IN)

(72) Inventors: Asha SYAMAKUMARI, Pune (IN); Ganesh Narsing KAMBLE, Pune (IN)

(21) Appl. No.: 18/726,357

(22) PCT Filed: Apr. 5, 2023
(86) PCT No.: PCT/IN2023/050332

§ 371 Date: Jul. 2, 2024

(30) Foreign Application Priority Data
Apr. 22, 2022 (IN) 202211024077

(51) Int. Cl. C08G 63/685; B33Y 70/00

(52) U.S. Cl. CPC C08G 63/6856; B33Y 70/00

(57) ABSTRACT

The present invention relates to a composition comprising L-Glutamic acid and L-Aspartic acid based aliphatic, photocurable polyester crosslinkers of Formula (I) and its application for 3D printing, wherein. X=1 (L-Aspartic acid) or 2 (L-Glutamic acid): R=Dansyl or Acryloyl; and n=12 to 15.

### TECHNICAL FIELD OF THE INVENTION

The present invention relates to an amino acid-based biodegradable, photocurable composition for 3D printing application. More particularly, the present invention relates to a biodegradable composition comprising L-Glutamic acid and L-Aspartic acid based aliphatic, photocurable polyester crosslinker(s) of Formula (I) and its application for 3D printing.

### BACKGROUND AND PRIOR ART RELATED THE INVENTION

Among the various additive manufacturing technologies, light based additive manufacturing involving photopolymerization is a simple and convenient method for achieving high resolution 3D printed objects under gentle processing conditions that are very amenable for bio 3D printing. The materials are made photocurable by structural modifications of natural or biocompatible synthetic polymers with polymerizable functionalities like the (meth)acrylic unit, vinyl unit etc. Among the various biocompatible polymers that are suitable for bio applications are aliphatic polyesters based on glycolic acid, L-lactic acid, ε-caprolactone, etc which have been shown to undergo 100% enzymatic degradation under physiological conditions.

3D printing for medical applications also have focused on these classes of materials mostly. The article entitled “Poly(propylene fumarate) stars, using architecture to reduce the viscosity of 3D printable resins” by ML Becker et al and published in the journal “Polym. Chem., 2019, 10,4655” demonstrated 3D printed resorbable tissue engineering scaffolds using Poly(propylene fumarate) (PPF), which is an unsaturated polyester. Another article entitled “Versatile Biodegradable Poly(ester amide)s Derived from α-Amino Acids for Vascular Tissue Engineering” by Amin S. Rizkalla et. al and published in the journal “Materials 2010, 3, 2346-2368” reports amino acid based polymers like the family of poly(ester amide)s (PEAs) are considered as potential biodegradable polymers with good processing properties that are susceptible to enzymatic as well as hydrolytic degradation.

An article entitled “Amyloid-Like Hierarchical Helical Fibrils and Conformational Reversibility in Functional Polyesters Based on 1-Amino Acids” by Jayakannan et al and published in the journal “Biomacromolecules 2015, 16, 1009-1020” reports novel and unique dual ester-urethane solvent-free melt polycondensation chemistry which enabled the synthesis of nonpeptide functional polyesters based on natural L-amino acids.

Further, another article published in the journal “Biomacromolecules 2012, 13, 2446-2455” and entitled “Polymers from Amino acids: Development of Dual Ester-Urethane Melt Condensation Approach and Mechanistic Aspects” by same group of Jayakannan et al could make use of the unique temperature selective reactivity of ester and urethane functional groups toward the alcohol to develop functional polyesters based on amino acids like L-aspartic acid and L-glutamic acid. Natural amino acids like the aspartic and glutamic acids possessing two carboxyl and one amine functional groups were converted to methyl esters and urethane (carbamate) functional group respectively with methanol and Boc anhydride. Upon reaction with suitable diols, the ester group underwent melt polycondensation selectively to produce linear polyesters leaving the urethane functional group intact on each repeat unit. This process makes available a wonderful opportunity to further functionalize the polymer into polymeric crosslinkers by utilizing the amine functionality.

Despite the progress in material development for 3D printing in general, the palette of materials available for 3D printing in the biomedical field is not very large due to the stringent requirements that the materials used for such applications have to adhere to in order to obtain approval for use in humans.

Therefore, there is a need for the development of more and more new materials that can meet the functional requirements of customized 3D printing technologies with better resolution or clarity.

### OBJECTIVES OF THE INVENTION

The main objective of the present invention is to provide a biodegradable composition comprising amino acid based aliphatic, photocurable polyester crosslinker of Formula (I).

Another objective of the present invention is to provide a biodegradable composition comprising L-Glutamic acid and/or L-Aspartic acid based aliphatic, photocurable polyester crosslinkers of Formula (I).

Another objective of the present invention is to provide an application of a composition comprising L-Glutamic acid and L-Aspartic acid based aliphatic, photocurable polyester crosslinkers of formula (I) for 3D printing.

Another objective of the present invention is to provide a composition comprising L-Glutamic acid and L-Aspartic acid based aliphatic, photocurable polyester crosslinkers of Formula (I), wherein said composition is biodegradable.

Yet another objective of the present invention is to provide a process for preparation of said composition comprising L-Glutamic acid and L-Aspartic acid based aliphatic, photocurable polyester crosslinkers of Formula (I).

Yet another objective of the present invention is to provide a process for preparation of acryloyl functionalized L-Glutamic acid and/or L-Aspartic acid based aliphatic, photocurable polyester crosslinker of Formula (I).

Still another objective of the present invention is to provide a process for preparation of dansyl functionalized L-Glutamic acid and/or L-Aspartic acid based aliphatic, photocurable polyester crosslinker of Formula (I).

### SUMMARY OF THE INVENTION

Accordingly, to accomplish the objectives, the present invention provides a biodegradable composition comprising L-Glutamic acid and/or L-Aspartic acid based aliphatic, photocurable polyester crosslinkers of Formula (I).

In an aspect, the present invention relates to a biodegradable composition for 3D printing comprising:
a) an amino acid based aliphatic, photocurable polyester crosslinker(s) polymer of Formula (I),
b) a diluent, and
c) a photoinitiator;
   wherein the crosslinker polymer of Formula (I) is represented by:

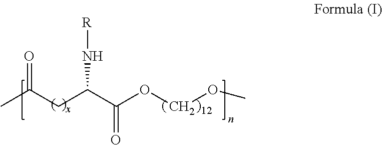

wherein,
X=1 (L-Aspartic acid) or 2 (L-Glutamic acid);

### R=Dansyl or Acryloyl; and

n=12 to 15.

In another aspect, the crosslinker polymer is selected from acryloyl functionalized L-Glutamic acid and/or L-Aspartic acid based aliphatic, photocurable polyester or Dansyl functionalized L-Glutamic acid and L-Aspartic acid based aliphatic, polyester.

In another aspect, the diluent is selected from hydroxyethyl methacrylate (HEMA), hydroxy ethyl acrylate (HEA) or mixture thereof.

In another aspect, the photoinitiator is diphenyl (2,4,6-trimethyl benzoyl) phosphine oxide or 2-hydroxy-2-methylpropiophenone.

In another aspect, the present invention relates to a process for preparation of the biodegradable composition for 3D printing, comprising mixing the diluent, the amino acid based crosslinker and the photoinitiator under sonication for 1 to 1.5 hrs at temperature ranging between 25 to 30° C.

In another aspect, the amount of diluent is in range of 77.16 to 94.5 wt. % of total weight of the composition/process; amount of the amino acid based aliphatic, photocurable polyester crosslinker polymer is in range of 4.0 to 20 wt. % of total weight of the composition/process; and amount of photoinitiator is in range of 1 to 2 wt. % of total weight of the composition/process. Specifically, the amount of diluent is 94.5 wt. % of total weight of the composition/process; amount of the amino acid based aliphatic, photocurable polyester crosslinker polymer is 4.0 wt. % of total weight of the composition/process; and amount of photoinitiator is in range of 1.5 wt. % of total weight of the composition/process.

In another aspect, the biodegradable composition further comprises dansyl functionalized glutamic acid based polyester as light absorber, in an amount ranging between 1.34 to 2 wt. % of total weight of composition/process. Specifically, the amount of dansyl functionalized glutamic acid based polyester as light absorber in said composition/process is in amount of around 1.34 wt. %.

In another aspect, the amount of hydroxyethylmethacrylate (HEMA) or hydroxy ethyl acrylate (HEA) is in range of 77.16 to 94.5 wt. % of total weight of the composition/process; amount of the amino acid based aliphatic, photocurable polyester crosslinker is in range of 4.0 to 20 wt. % of total weight of the composition/process; and amount of Diphenyl (2,4,6-trimethyl benzoyl) phosphine oxide is in range of 1 to 2 wt % of total weight of the composition/process. Specifically, the amount of hydroxyethylmethacrylate (HEMA) or hydroxy ethyl acrylate (HEA) is 94.5 wt. % of total weight of the composition/process; amount of the amino acid based aliphatic, photocurable polyester crosslinker is 4.0 wt. % of total weight of the composition/process; and amount of Diphenyl (2,4,6-trimethyl benzoyl) phosphine oxide is 1.5 wt. % of total weight of the composition/process.

In another aspect, the ratio of said diluent: amino acid based crosslinker: photoinitiator is 0.945:0.04:0.015.

In another aspect, the present invention provides a process for the preparation of Acryloyl functionalized L-Glutamic acid and/or L-Aspartic acid based aliphatic, photocurable polyester crosslinker of Formula (I), wherein said process comprises the steps of:
a. treating amino acid (1) with SOCl₂ in the presence of suitable solvent at a temperature in the range of 25-30° C. for a period in the range of 10-12 hours;
b. protecting the obtained product at step a) with di-tert-butyl-dicarbonate in the presence of a suitable solvent at a temperature in the range of 25-30° C. for a period in the range of 10-12 hours to afford compound (2);
c. condensing dodecanediol with the protected product obtained at step b) in the presence of 1 mol % titanium (IV) butoxide at a temperature in the range of 110-120° C. for a period in the range of 2-4 hours to afford compound (3);
d. deprotecting the compound obtained at step c) with TFA in a suitable solvent at a temperature in the range of 25-30° C. for a period in the range of 5-6 hours to afford compound (4); and
e. reacting the polymer obtained at step d) with acryloyl chloride in the presence of base in a suitable solvent at a temperature in the range of 25-30° C. for a period in the range of 10-12 hours to obtain acryloyl functionalized amino acid based polyester crosslinker of Formula (I).

In another aspect, the present invention provides a process for the preparation of Dansyl functionalized L-Glutamic acid and/or L-Aspartic acid based aliphatic, polyester of formula (I), wherein said process comprises the steps of:
a. treating amino acid (1) with dansyl chloride in the presence of a base in a suitable solvent at a temperature in the range of 25-30° C. for a period in the range of 10-12 hours to afford N-dansyl amino ester monomer to afford compound (5); and
b. condensing dodecanediol with the monomer obtained at step a) in the presence of 1 mol % titanium (IV) butoxide at a temperature in the range of 110-120° C. for a period in the range of 2-4 hours to afford dansyl functionalized amino acid-based polyester of Formula (I).

Another embodiment of the present invention provides a biodegradable composition comprising L-Glutamic acid and L-Aspartic acid based aliphatic, photocurable polyester crosslinkers of formula (I) for 3D printing; wherein said composition comprises of 94.5 wt % of hydroxyethylmethacrylate (HEMA) with 4.0wt % amino acid based crosslinker along with 1.5 wt % of Diphenyl (2,4,6-trimethyl benzoyl) phosphine oxide as photoinitiator (PI).

Another aspect of an embodiment of the present invention provides a process for the preparation of a biodegradable composition comprising L-Glutamic acid and L-Aspartic acid based aliphatic, photocurable polyester crosslinkers of formula (I) for 3D printing; wherein said process comprises of mixing a constant concentration of 94.5 wt % of hydroxyethylmethacrylate (HEMA) with 4.0 wt % amino acid based crosslinker (PG-Ac or PA-Ac) along with 1.5 wt % of Diphenyl(2,4,6-trimethylbenzoyl) phosphine oxide as photoinitiator (PI). Formulations are also formed by incorporating Dansyl functionalized Glutamic acid polyester (1.34 wt %) as light absorber to improve the resolution of the 3D printed objects. The formulations were sonicated for one and half hour to make it homogeneous before using it for 3D printing.

Another embodiment of the present invention provides a composition comprising L-Glutamic acid and L-Aspartic acid based aliphatic, photocurable polyester crosslinkers of formula (I) for 3D printing; wherein said composition is biodegradable.

These and other features, aspects, and advantages of the present subject matter will be better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter.

### BRIEF DESCRIPTION OF THE DRA WINGS

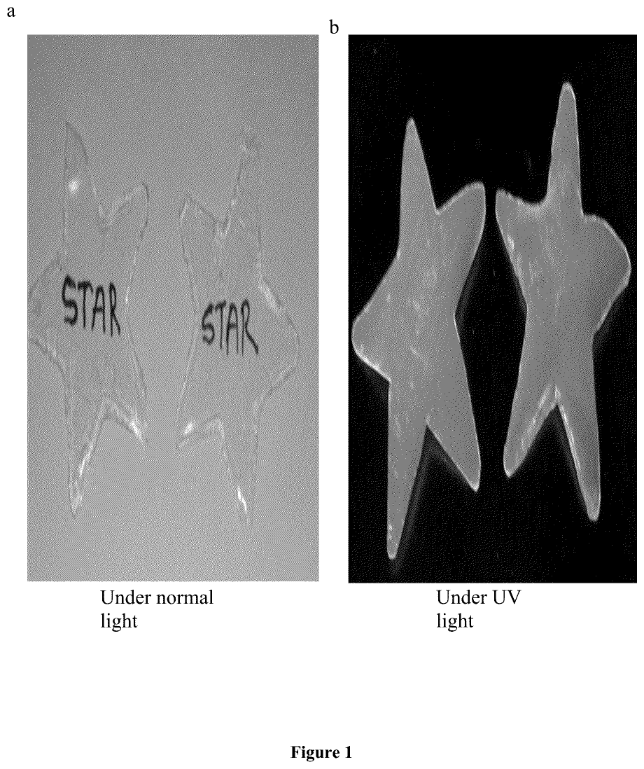

FIG. 1 depicts 3D printing image of the objects, in accordance with an embodiment of the present disclosure.

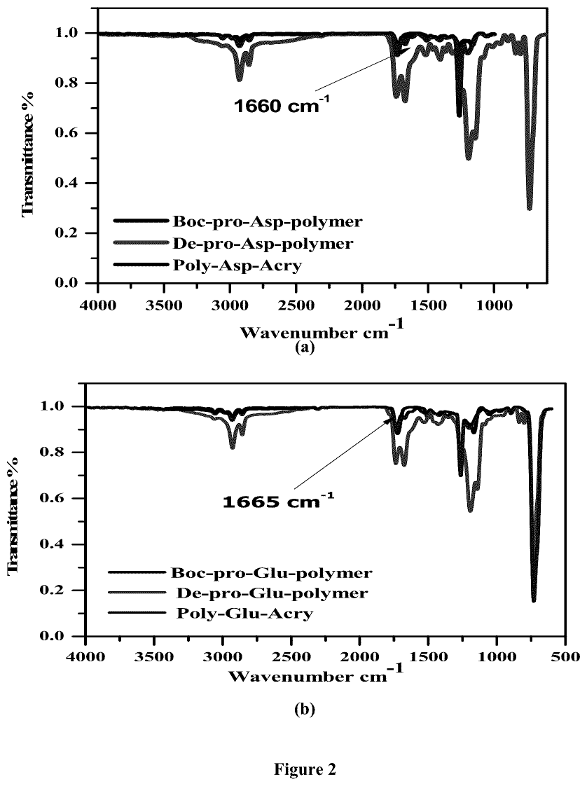

FIG. 2 depicts comparison of the FTIR spectra of (a) Boc-Glu-Polymer, Depro-Glu-polymer and PG-Ac; (b) Boc-pro-Asp-Polymer, Depro-Asp-polymer and PA-Ac, in accordance with an embodiment of the present disclosure.

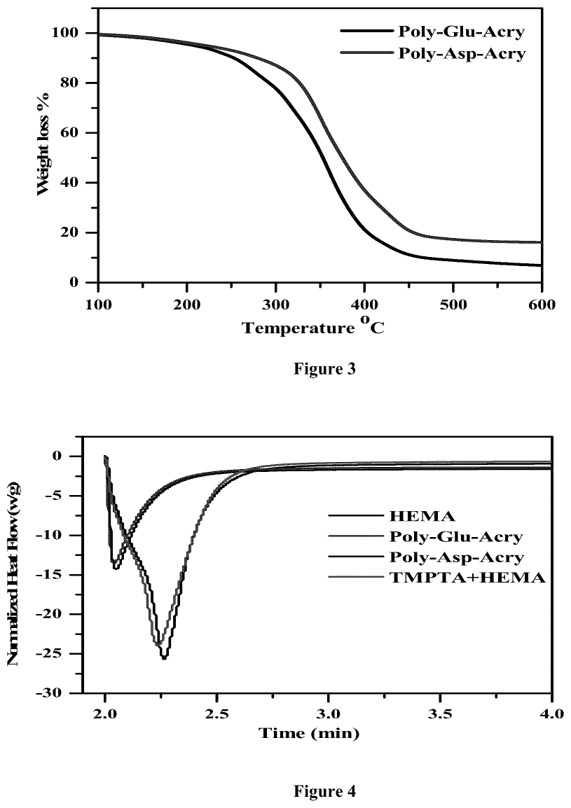

FIG. 3 shows TGA analysis, in accordance with an embodiment of the present disclosure.

FIG. 4 compares the photo DSC curves of the two amino acids based photocurable formulations along with that for HEMA alone and HEMA with TMPTA as the crosslinker at 1.5 wt % PI concentration, in accordance with an embodiment of the present disclosure.

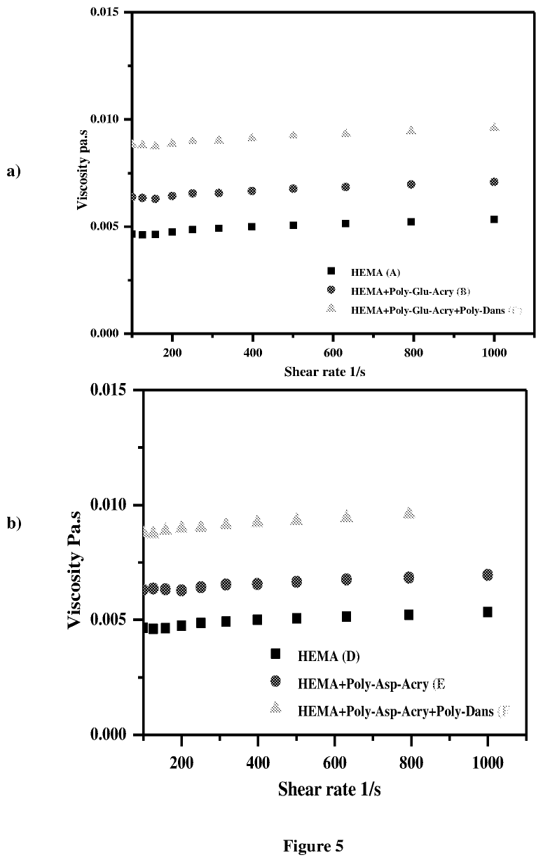

FIG. 5 depicts plot of viscosity of resin formulations (without photo initiator) versus shear rate (1/s), in accordance with an embodiment of the present disclosure.

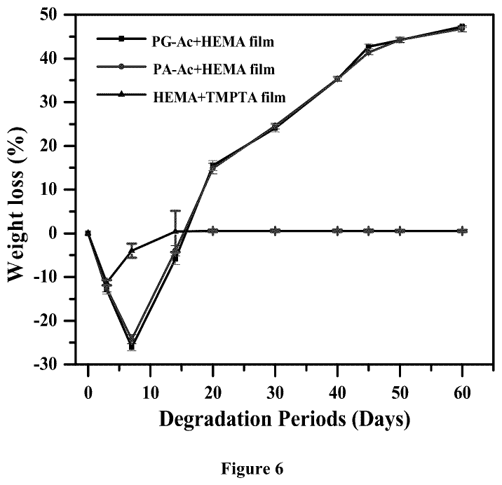

FIG. 6 shows percent Weight loss of 3D printed films in PBS at 37° C. upto 60 days, in accordance with an embodiment of the present disclosure.

### ACCRONYMS USED TO DESCRIBE THE INVENTION

HEMA: Hydroxyethylmethacrylate;
TMPTA: Trimethylolpropane triacrylate;
PG-Ac: acryloyl functionalized glutamic acid based polyester crosslinker; and
PA-Ac: acryloyl functionalized aspartic acid based polyester crosslinker.

### DETAILED DESCRIPTION OF THE INVENTION

Those skilled in the art will be aware that the present disclosure is subject to variations and modifications other than those specifically described. It is to be understood that the present disclosure includes all such variations and modifications. The disclosure also includes all such steps, features, compositions, and compounds referred to or indicated in this specification, individually or collectively, and any and all combinations of any or more of such steps or features.

### Definitions

For convenience, before further description of the present disclosure, certain terms employed in the specification, and examples are delineated here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The invention has other advantages and features which will be more readily apparent from the following detailed description of the invention, when taken in conjunction with the accompanying drawings.:

While the invention has been disclosed with reference to certain embodiments, it will be understood by those skilled in the art that various changes may be made, and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate parts throughout the view. Additionally, a reference to the singular includes a reference to the plural unless otherwise stated or inconsistent with the disclosure herein.

It is to be understood that the figures and descriptions of the present invention have been simplified to illustrate elements that are relevant for a clear understanding of the invention. The detailed description will be provided herein below with reference to the attached drawing.

The terms “amino acid based aliphatic, photocurable polyester”, “L-Glutamic acid and L-Aspartic acid based aliphatic, photocurable polyester”, “crosslinker” or “polymer” are used herein interchangeably.

The present invention provides a biodegradable composition comprising L-Glutamic acid and L-Aspartic acid based aliphatic, photocurable polyester crosslinkers of Formula (I).

In an embodiment, the present invention provides a biodegradable composition comprising L-Glutamic acid and L-Aspartic acid based aliphatic, photocurable polyester crosslinkers of Formula (I):

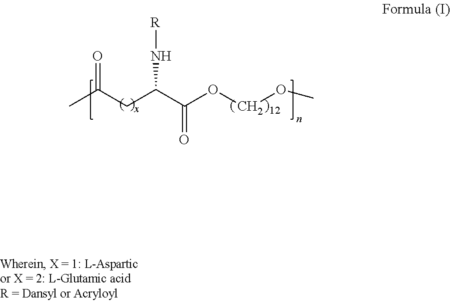

wherein,
X=L-Aspartic acid or L-Glutamic acid;
R=Dansyl or Acryloyl;
n=12-15

In another aspect of an embodiment, the present invention provides a process for the preparation of Acryloyl functionalized L-Glutamic acid and L-Aspartic acid based aliphatic, photocurable polyester crosslinkers of Formula (I), wherein said process comprises the steps of:
a. treating amino acid (1) with SOCI2 in the presence of suitable solvent at a temperature in the range of 25-30° C. for a period in the range of 10-12 hours;
b. protecting the obtained product at step a) with di-tert-butyl-dicarbonate in the presence of a suitable solvent at a temperature in the range of 25-30° C. for a period in the range of 10-12 hours to afford compound (2);
c. condensing dodecanediol with the protected product obtained at step b) in the presence of 1 mol % titanium (IV) butoxide at a temperature in the range of 110-120° C. for a period in the range of 2-4 hours to afford compound (3);
d. deprotecting the compound obtained at step c) with TFA in a suitable solvent at a temperature in the range of 25-30° C. for a period in the range of 5-6 hours to afford compound (4); and
e. reacting the polymer obtained at step d) with acryloyl chloride in the presence of base in a suitable solvent at a temperature in the range of 25-30° C. for a period in the range of 10-12 hours to obtain acryloyl functionalized amino acid based polyester crosslinker of Formula (I).

Suitable solvents used in the process are selected from a group consisting of methanol, trichloromethane, dichloromethane, and chloroform.

Base used at step e) is selected from organic bases such as methyl amine, pyridine, triethyl amine, diisopropyl ethyl amine. In particularly useful embodiment, triethyl amine is used as a base at step e).

In another aspect of an embodiment, the present invention provides a process for the preparation of Dansyl functionalized L-Glutamic acid and L-Aspartic acid based aliphatic, polyester of Formula (I), wherein said process comprises the steps of:
a. treating amino acid (1) with dansyl chloride in the presence of a base in a suitable solvent at a temperature in the range of 25-30° C. for a period in the range of 10-12 hours to afford N-dansyl amino ester monomer to afford compound (5); and
b. condensing dodecanediol with the monomer obtained at step a) in the presence of 1 mol % titanium (IV) butoxide at a temperature in the range of 110-120° C. for a period in the range of 2-4 hours to afford dansyl functionalized amino acid-based polyester of Formula (I).

Suitable solvent used at step a) is selected from methanol, ethanol, isopropanol, THF, dichloromethane, chloroform, ethyl acetate. In a particularly useful embodiment, dichloromethane is used as a solvent at step a).

Base used at step a) is selected from organic bases such as methyl amine, pyridine, triethyl amine, diisopropyl ethyl amine. In a particularly useful embodiment, triethyl amine is used as a base at step a).

The process is depicted below in scheme-1:

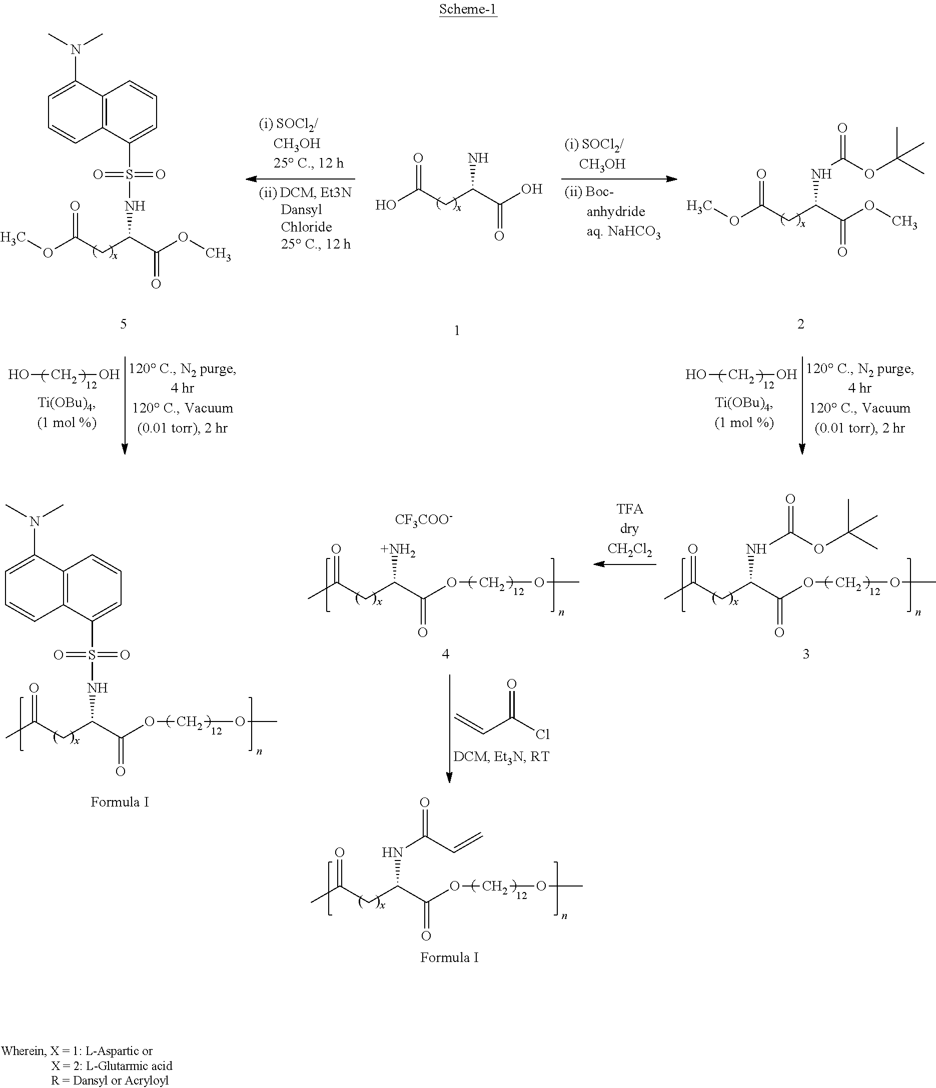

Another embodiment of the present invention provides a biodegradable composition comprising L-Glutamic acid and/or L-Aspartic acid based aliphatic, photocurable polyester crosslinkers of formula (I) for 3D printing; wherein said composition comprises of 94.5 wt % of hydroxyethyl methacrylate (HEMA) with 4.0 wt % amino acid based crosslinker along with 1.5 wt % of diphenyl (2,4,6-trimethyl benzoyl) phosphine oxide as photo initiator (PI).

Another aspect of an embodiment of the present invention provides a process for the preparation of a composition comprising L-Glutamic acid and L-Aspartic acid based aliphatic, photocurable polyester crosslinkers of formula (I) for 3D printing; wherein said process comprises of mixing a constant concentration of 94.5 wt % of hydroxyethylmethacrylate (HEMA) with 4.0 wt % amino acid based crosslinker (PG-Ac or PA-Ac) along with 1.5 wt % of diphenyl (2,4,6-trimethylbenzoyl) phosphine oxide as photoinitiator (PI). Formulations are also formed by incorporating Dansyl functionalized Glutamic acid polyester (1.34 wt %) as light absorber to improve the resolution of the 3D printed objects. The formulations were sonicated for one and half hours to make it homogeneous before using it for 3D printing.

Resolution of the 3D printed objects could be improved by incorporating a Dansyl labeled L-Glutamic acid polyester, which not only aided in modulating the viscosity of the resin formulation but could also function as a light blocker, thereby avoiding polymerization of unwanted areas while 3D printing. The availability of new photocurable formulations that are biocompatible or biodegradable are highly sought after for 3D printing applications like 3D printed bio implantable.

Compositions are also formed by incorporating Dansyl functionalized Glutamic acid polyester (1.34 wt %) as light absorber to improve the resolution of the 3D printed objects. The compositions are sonicated for one and half hours to make it homogeneous before using it for 3D printing.

The printing ability of the amino acid-based resin formulation is evaluated using the four resins. Two without addition of dansyl homopolymer and two in addition of dansyl polymer. All 3D printing is done on a DLP based 3D printer (Digital light processing 3D printer). Solus contour software is used. Dimensions of the 3D object is (41.3*39.3*0.9 mm) the layer thickness of the 3D printed object is set at 30 μm and the number of initial layers is 3 and exposure time is set 30 seconds for initial layers and for rest of the layer 4 seconds. Designed structure is successfully printed without any addition of organic solvent. The 3D printed objects are immersed in isopropanol to remove any uncured oligomers or monomers. Two resins could successfully 3D print films of 500 microns thickness which are further used for the mechanical test measurement. Similarly, Dansyl chromophore functionalized glutamic acid polyester 1.34 wt % containing resin formulations are also introduced to printing. The dimensions of the printed object are (24.3*25.4*3 mm). The layer thickness of the 3D printed object is set at 30um and the number of initial layers is 8 and exposure time is set 31 seconds for initial layers and rest of the layer 8 seconds. After completion of printing the 3D printed objects are immersed in isopropanol to remove any uncured oligomers or monomers. Image of 3D printed objects as shown in FIG. 1 is made using a) PG-Ac and PA-Ac and b) incorporation dansyl homopolymer.

### Thermal Properties of 3D Printed Parts

FIG. 2 depicts comparison of the FTIR spectra of (a) Boc-Glu-Polymer, Depro-Glu-polymer and Poly-Glu-Acry; (b) Boc-pro-Asp-Polymer, Depro-Asp-polymer and PA-Ac. The quantitative conversion is estimated by comparison of the proton integration of the double bonds with that of the CO(O)CH₂ peak protons. FTIR spectroscopy also confirms the acrylation by the appearance of new peaks at 1675 cm⁻¹ in case PG-Ac and 1675 cm⁻¹ for PA-Ac of corresponding to C═C stretching frequency respectively. FIG. 2 shows the stack plot of the FTIR spectra before and after acrylation for Boc-Glu-polymer, Depro-Glu-polymer and PG-Ac.

FIG. 3 shows TGA analysis. The thermal characterization of the polymers both before and post functionalization is carried out using Thermogravimetric analysis (TGA) and differential scanning calorimetry (DSC). The thermogram exhibited two distinct decomposition regions corresponding to cleavage of the urethane linkage (220-240° C.) and to ester backbone decomposition at higher temperatures (>300° C.) respectively. The Differential Scanning calorimetric analysis of the polymers indicated the amorphous nature of the amino acid polymers with glass transition temperature in the range of −11 to −13° C.

FIG. 4 compares the photo DSC curves of the two amino acids based photocurable formulations along with that for HEMA alone and HEMA with TMPTA as the crosslinker at 1.5 wt % PI concentration. The theoretical heat of polymerization (ΔHₚ) of HEMA is calculated as 421.16 J/g based on literature (R. Harikrishna et al; J Polym Res (2012) 19:9811). value for heat of polymerization of 13.1 Kcal/mol per methacrylate double bond. Comparing this value with the experimentally obtained enthalpy of curing, HEMA achieved 92.8% conversion in the photo DSC measurement. Similarly, the theoretical heat of polymerization is calculated for the PG-Ac and PA-Ac based on literature values of 20.6 Kcal/mol peracrylate double bond. The calculated ΔHₚ values are 413.67 J/g for the HEMA+PG-Ac and 414.03 J/g for the HEMA+PA-Ac.

From the theoretical heat of polymerization for 100% double bond conversion the extent of cure observed for HEMA is calculated to be 91.41% while the percentage cure for the HEMA+PG-Ac and HEMA+PA-Ac oligomers are 94.27% and 86.80%, respectively at 1.5 wt. % of PI concentration. Table 2 lists the curing parameters determined for the 3 resin formulations A shoulder peak was observed in the reaction rate curve for HEMA, due to the fast reaction leading to microgel formation in the bulk material as reported in the literature (Li, L.; Lee, L. J. Polymer. 2005, 46, 11540-11547).

TABLE 2

| | Conc. of | Experimental | Theoretical | % |
|---|---|---|---|---|
| Sample | PI (wt %) | ΔH (J/g) | ΔH (J/g) | Conversion |
| HEMA | 1.5 | 385.00 | 421.16 | 91.41 |
| HEMA + | 1.5 | 387.00 | 439.21 | 88.11 |
| TMPTA | | | | |
| HEMA + PG-Ac | 1.5 | 390.00 | 413.67 | 94.27 |
| HEMA + PA-Ac | 1.5 | 359.40 | 414.03 | 86.80 |

For 20° C. DLP 3D printing, the viscosity of the photocurable resin is a critical parameter. Ideally, the viscosity of photo resin used in DLP 3D printing should not be more than or in the range of 0.14 to 4.6 Pa·s. In general, low viscosity permits appropriate sticking of the liquid resin between the end layer of the 3D model and the resin vat surface (Vincent S. D. Voet et al; ACS Omega 2018, 3, 1403-1408.) The increase in viscosity of resin formulation with the 1.34 wt. % addition of dansyl homopolymer in HEMA+PG-Ac which are determined using an isothermal parallel plate rotational rheometer. Newtonian nature or behavior is observed in all cases. Samples prepared of various compositions are (A) HEMA Alone (100 Wt % of HEMA) and (B) Mixture of HEMA with PG-Ac (96 Wt % HEMA and 4 Wt % of PG-Ac) have lower viscosity in contrast to (C) resin mixture of HEMA, PG-Ac, and dansyl polymer (94.66 Wt %, of HEMA 4.00 Wt % of PG-Ac and 1.34 Wt % of dansyl homopolymer) (C green) shows the higher viscosities because of the incorporation of dansyl polymer. It acts as viscosity enhancer and light absorber during the 3D printing.

Similarly, viscosity measurements are done for PA-Ac resin with same Wt %. Viscosity as a function of increased weight percentage of the dansyl homopolymer in a) PG-Ac in HEMA; b) PA-Ac in HEMA. Plot of viscosity of resin formulations (without photoinitator) versus shear rate (1/s) as shown in FIG. 5.

Table 3 and Table 4 show viscosity results of the various composition samples prepared.

TABLE 3
(with glutamic acid polymer)

| | HEMA | PG-Ac | PGDansyl | Viscosity |
|---|---|---|---|---|
| Sample code | Wt % | Wt % | Wt % | Pa · s |
| A | 100 | — | — | 0.0044 |
| B | 96.00 | 4 | — | 0.0061 |
| C | 94.66 | 4 | 1.34 | 0.0088 |

TABLE 4
(with aspartic acid polymer)

| | HEMA | PA-Ac | PGDansyl | Viscosity |
|---|---|---|---|---|
| Sample code | Wt % | Wt % | Wt % | Pa · s |
| D | 100 | — | — | 0.0044 |
| E | 96.00 | 4 | — | 0.0062 |
| F | 94.66 | 4 | 1.34 | 0.0088 |

Another embodiment of the present invention provides a composition comprising L-Glutamic acid and L-Aspartic acid based aliphatic, photocurable polyester crosslinkers of formula (I) for 3D printing; wherein said composition is biodegradable. The composition comprises 94.5 wt % of hydroxyethyl methacrylate (HEMA) with 4.0 wt % amino acid based crosslinker along with 1.5 wt % of diphenyl (2,4,6-trimethyl benzoyl) phosphine oxide as photo initiator (PI).

### Enzymatic Degradation

The in vitro enzymatic degradation of the 3D printed films of HEMA incorporating PA-Ac and PG-Ac as the poly(amino acid)ester crosslinkers are compared with those of HEMA crosslinked with commercial crosslinker TMPTA as reference. The enzymatic degradation studies are undertaken for 60 days by placing the 3D printed specimen films in PBS buffer containing esterase enzyme at 37° C. Samples are taken out at regular intervals and evaluated for weight loss, with studies done in triplicate for all samples.

FIG. 6 compares the weight loss percentage for the 3D printed films of HEMA crosslinked with the two amino acid crosslinkers with that of 3D printed film of HEMA crosslinked with commercial crosslinker TMPTA. An initial increase in weight is observed for all samples due to swelling of the crosslinked films by uptake of water. The initial increase in weight is much less for the HEMA+TMPTA film compared to the other two samples. The amide linkage in the amino acid based crosslinker can engage in hydrogen bonding interaction with the water molecules leading to the large water uptake and swelling observed in the PA-Ac and PG-Ac crosslinked 3D printed HEMA films. The initial increase in weight is followed by loss of weight for the HEMA+amino acid crosslinker films as the degradation slowly started setting in. However, the HEMA+TMPTA film does not exhibit any observable change in weight during the entire course of degradation studies. In contrast, the poly(amino acid) crosslinked HEMA films exhibits >40% weight loss and continues to undergo further weight loss with almost identical weight loss characteristics.

### General Information

### 1H-NMR Spectroscopy

NMR spectra were recorded using a 400-MHz Brucker spectrophotometer in CDCl₃ containing small amounts of TMS as an internal standard. The polymer molecular weights were analyzed using a GPC analyzer using polystyrene as standard and THE as a solvent. The thermal stability of the polymer was analyzed using TA Discover 550 second generation Thermogravimetric analysis (TGA) instrument at a heating rate of 10° C. min⁻¹. The thermal analysis of the polymers were performed using TA Discover 250 second generation Differential Scanning calorimeter by heating from −30° C. to 180° C. at a heating rate of 10° C./min. Infrared spectra were recorded using a Perkin Elmer Spectrophotometer in the range of 4000 to 600 cm⁻¹. 3D printing was carried out using a commercial Solus Digital Light Processing (DLP) based printer, source intensity 31.67 Mw/cm² (solous counter software).

### Photo Differential Scanning Calorimeter (Photo DSC)

PhotoDSC studies were undertaken to record the rates of polymerization for the individual amino acid crosslinkers as well as for their formulations. The photocuring analysis were performed using TA Discover 250 second generation Differential Scanning calorimeter equipped with photo calorimetric unit (Onmi cure series 2000) having a 200 W high pressure mercury lamp for light source (wavelength 320-500 nm).

The photocurable mixture as prepared above was sonicated for 10 minutes and 5 mg was weighed into the DSC sample pan and allowed to equilibrate under isothermal conditions at 30° C. for 2 minutes under nitrogen flow.

### Viscosity

The viscosity of the photocurable formulations as a function of shear rate was determined using an MCR 301 Rheometer Cup and Bob instrument. The test was performed under a strain rate from 1 to 1000 per second at 30° C.

### 3D Printing

3D printing was carried out on a commercial Solus Digital light processing (DLP) 3D printer using solus contour software. Dimensions of the 3D printed object was (41.3×39.3×0.9 mm); the layer thickness was set at 30 μm, the number of initial layers was 3 and exposure time was set at 30 seconds for initial layers followed by 4 seconds for the remaining layers. The 3D printed objects were immersed in isopropanol to remove any uncured oligomers or monomers.

### EXAMPLES

Following examples are given by way of illustration and therefore should not be construed to limit the scope of the invention.

### Materials

L-Glutamic acid, L-Aspartic acid, Thionyl chloride, and trifluoroacetic acid were purchased from (Avra Laboratories Pvt. Ltd), NaHCO₃, Na₂CO₃ and K₂CO₃ were purchased from Merck. Titanium (IV) butoxide, 1,12-dodecandiol, acrylic acid, Hydroxyethylmethacrylate (HEMA), 2-hydroxy-2-methylpropiophenone, Diphenyl (2,4,6-trimethyl benzoyl) phosphine oxide (TPO) were purchased from Aldrich and used as such without further purification. Di-tert-butyl dicarbonate (Boc. Anhydride), Triethylamine (Emparta), Diethyl ether (Et₂O), Tetrahydrofuran (THF), Chloroform (CHC13), Methanol (MeOH), Dichloromethane (DCM), Ethyl acetate, petroleum ether, were purchased locally. Solvents were dried by standard drying procedures before use. Acryloyl chloride was synthesized in lab.

### Example 1: Synthesis of N-Boc L-Glutamate Monomer (2)

L-Glutamic acid (10 g, 67.9 mmol) and dry MeOH (100 ml) were taken in round bottom flask along with stir bar after evacuating air followed by purging N₂ gas. SOCl₂ (10.5 ml, ˜17 g, 142.5 mmol) was added dropwise under cold conditions. The reaction mixture was stirred at 30° C. for 12 hours. After completion of the reaction, the unreacted MeOH/SOCl₂ was removed by using vacuum distillation. The product (L-Glutamic acid methyl ester) was obtained as a colorless viscous liquid. The obtained glutamate ester (5 g, 28.40 mmol) was taken in CHCl₃ and saturated solution of Na₂CO₃ (6.2 g, 56.8 mmol) was added. Di-tert-butyl dicarbonate (Boc. Anhydride) dissolved in CHCl₃, (5.02 g, 42.61 mmol) was added dropwise under cold condition and stirred at 30° C. for 12 hours. For workup, the reaction mixture was extracted with DCM followed by washing the organic layer with water and brine. The crude product was further purified by column chromatography using 70:30 pet ether:ethyl acetate as eluent. Yield: 4.5 g (57.61%). ¹H NMR (400 MHz, CDCl₃): δ in ppm 5.15 (broad, 1H), 4.31 (broad, 1H), 3.72 (s, 3H), 3.65 (s, 3H), 2.36-2.42 (m, 2H), 2.12-2.20 (m, 1H), 1.89-1.97 (m, 1H), 1.41 (s, 9H). ¹³C NMR (100 MHz, CDCl₃) δ in ppm 173.08, 172.58, 155.27, 79.89, 52.76, 52.31, 51.68, 29.96, 28.18, 27.64. FT-IR (cm⁻¹) 3368, 2974, 1723, 1512, 1437, 1356, 1240, 1206, 1159, 1057.

Similarly, N-Boc L-Aspartate monomer was prepared following the above procedure but using L-Aspartic acid.

### Example 2: Synthesis of Compound (3)

N-Boc L-Glutamate monomer (2 g, 7.27 mmol) was taken in a dry schlenk tube. Dodecanediol (1.47 g, 7.27 mmol) was added and the entire mixture was heated at 120° C. followed by purging N₂ gas. This was followed by addition of 1 mol % titanium (IV) butoxide (0.024 g, 0.0727 mmol) as catalyst. After 4 hours, the viscous solution was subjected to high vacuum for 2 hours. The product was obtained as faint yellowish viscous liquid. Yield: 2.97 g (98.67%). ¹H NMR (400 MHz, CDCl₃): δ in ppm 5.12 (broad, 1H), 4.30 (broad, 1H), 4.12 (t, 2H), 4.6 (t, 2H), 2.36-2.42 (m, 2H), 2.13-2.21 (m, 1H), 1.88-1.98 (m, 1H), 1.58-1.67 (broad, 4H), 1.44 (s, 9H), 1.27 (broad, 16H). ¹³C NMR (100 MHz, CDCl₃) δ in ppm 172.94, 171.95, 155.25, 79.90, 65.67, 64.85, 51.53, 36.46, 31.84, 29.62, 29.42,29.28, 27.38, 14.04. FT-IR (cm⁻¹) 3055, 2913, 2865, 1710, 1485, 1275, 1172, 1060, 890, 740.

Similarly, the N-Boc L-Aspartate monomer was polymerized with 1,12-dodecanediol to form linear functional polyester.

### Example 3: Deprotection of Functional Polyester to Synthesis Compound (4)

Protected polymer (3 g, 7.28 mmol) was taken in a small round bottom flask, 10 ml of dry DCM was added and stirred for 10 min to form a homogeneous liquid. 4.15 g (2.8 ml, 36.4 mmol) of TFA was added dropwise under cold conditions and the reaction was left for 6 h at 30° C. The excess TFA was removed by using a rotary evaporator. The obtained product was dissolved in DCM and it was precipitated in diethyl ether and dried under vacuum. Yield: 2 g (88.10%). ¹H NMR (400 MHz, CD₃OD): δ in ppm 5.12 (broad, 1H), 4.30 (broad, 1H), 4.12 (t, 2H), 4.6 (t, 2H), 2.36-2.42 (m, 2H), 2.13-2.21 (m, 1H), 1.88-1.98 (m, 1H), 1.58-1.67 (broad, 4H), 1.27 (broad, 16H). ¹³C NMR (100 MHz, CDCl₃) δ in ppm 172.20, 168.76, 66.34, 64.73, 61.60, 51.80, 32.27, 29.34, 28.99, 25.67, 25.28, 25.16, 25.55, 25.27. FT-IR (cm⁻¹) 2920, 2850, 1745, 1540, 1410, 1260, 1180, 1125, 850, 730.

The L-Aspartic acid-based polymer was deprotected in a similar way.

### Example 4: Post Functionalization of Amine Functionalized Polymer With Acryloyl Chloride to Afford Compound of Formula (I) (Acryloyl Functionalized)

Poly-glutamate dimethyl ester (2.5 g, 8.01 mmol) was dissolved in anhydrous DCM (20 ml) under N₂ atmosphere and triethylamine (2.23 ml, 16.02 mmol) was added to neutralise it. 0.8 ml (0.87 g, 9.61 mmol) of acryloyl chloride taken in 5 ml of DCM was added to the polymer solution (polymer+Et₃N+DCM) dropwise under cold condition. The reaction mixture was stirred for 12 hours. The mixture was poured into water and trice extracted with DCM. Yield: 1.7 g (58.62%). ¹H NMR (400 MHz, CDCl₃): δ in ppm 5.68 (d, 1H), 6.47 (broad, 1H), 6.28-6.33 (dd, 1H), 4.67-4.72 (m, 1H), 4.13-4.17 (t, 2H), 4.4-4.7 (t, 3H), 2.37-2.48 (m, 2H), 2.22-2.29 (m, 1H), 2.2-2.7 (m, 1H), 1.591.67 (broad, 4H), 1.27-1.30 (broad, 16H). ¹³C NMR (100 MHz, CDCl₃) δ in ppm 173.40, 172.27, 165.57, 130.58, 128.91, 127.56, 66.19, 65.29, 52.11, 30.66, 29.80, 29.54, 28.83, 28.76. FT-IR (cm⁻¹) 3055, 2925, 2860, 1725, 1530, 1420, 1255, 1200, 880, 725.

The L-Aspartic acid-based polymer was post functionalized with acryloyl chloride in a similar way.

### Example 5: Synthesis of N-Dansyl L-Glutamate Monomer (5)

The glutamate ester (5.5 g, 31.25 mmol) in dry DCM, (50 ml) was taken in a round bottom flask and 8.71 ml of (6.32 g, 62.5 mmol) triethylamine was added to it. A solution of dansyl chloride in DCM was added dropwise under the cold condition and the reaction was left for 12 hours at 30° C. For workup, the reaction mixture was extracted with DCM, followed by washing the organic layer with water and brine. It was further purified by column chromatography using 70:30 pet ether: ethyl acetate as eluent. Yield: 3.95 g (31.00%) ¹H NMR (400 MHz, CDCl₃): δ in ppm 2.89 (s, 6H), 3.61 (s, 3H), 3.29 (s, 3H), 2.35 (D, 1H), 2.04 (t, 2H), 1.83 (t, 2H), 3.98 (d, 1H), 8.55 (d, 1H), 8.30 (d, 1H), 8.22 (d, 1H), 7.63 (d, 1H), 7.54 (d, 1H), 7.20 (d, 1H). ¹³C NMR (100 MHz, CDCl₃) δ in ppm 172.98, 171.41, 134.24, 130.91, 129.96, 129.84, 128.62, 123.23, 118.83, 115.38, 55.26, 52.46, 45.51, 29.34, 28.09.

### Example 6: Melt Polycondensation of N-Dansyl L-Glutamate Monomer of Formula (I) (Dansyl Functionalized)

N-Dansyl L-Glutamate monomer (0.5 g, 1.225 mmol) was taken in a dry dry shlenk tube. Dodecandiol (0.25 g, 1.225 mmol) was added and the entire mixture was heated at 120° C. followed by purging N₂ gas. This was followed by addition of 1 mol % titanium (IV) butoxide (0.004 g, 0.0122 mmol) as catalyst. After 4 hours the viscous solution was subjected to high vacuum for 2 hours. The product was obtained as a faint yellowish highly viscous product. Yield: 0.72 g (98.63%) ¹H NMR (400 MHz, CDCl₃): δ in ppm 2.89 (s, 6H), 3.93 (t, 2H), 3.65 (t, 2H), 2.35 (d, 1H), 2.04 (t, 2H), 1.83 (t, 2H), 3.98 (d, 1H), 8.55 (d, 1H), 8.30 (d, 1H), 8.22 (d, 1H), 7.63 (d, 1H), 7.54 (d, 1H), 7.20 (d, 1H), 1.28 (Broad 16H), 1.60 (broad 4H). ¹³C NMR (100 MHZ, CDCl₃) δ in ppm 172.69, 151.97, 130.85, 129.83, 129.69, 128.59, 123.34, 123.16, 118.36, 115.36, 65.91, 64.95, 55.43, 45.50, 30.73, 29.62, 29.54, 29.37, 29.19, 28.62, 25.98.

### Example 7: In Vitro Degradation Studies

Thin films of dimension 41.3×39.3×0.9 mm are 3D printed using the resin formulations (HEMA 96 wt %+PA-Ac 4 wt %) and (HEMA 96 wt %+PG-Ac 4 wt %) and cut into square samples and weighed. Reference films are 3D printed using resin formulation HEMA 96 wt %+TMPTA 4 wt % and square samples are cut out for these films also. The square specimens are taken in sealed 2 k dialysis tubes with 10 mL PBS solution containing 5 mg esterase enzyme and immersed in PBS buffer solution (150 mL; pH 7.4) at 37° C. The buffer solutions are prepared following the literature procedure (Lavilla, C.; Alla, A.; Mart, A. High Tg Bio-Based Aliphatic Polyesters from Bicyclic. 2013 and Saxena, S.; Jayakannan, M. Development Of. 2020. https://doi.org/10.1021/acs.biomac.9b01124.) 8 gm (0.137 mol) of NaCl, 0.2 gm (0.003 mol) of KCl, 1.44 gm (0.010 mol) of Na₂HPO₄ and 0.24 gm (0.002 mol) of KH₂PO₄ were dissolved in 1000 mL of deionized water. Once a homogeneous solution is formed, pH 7.4 is maintained by adding HCL and used for degradation studies. Every week PBS solution and esterase enzyme is replaced to maintain concentration and enzyme activity respectively. The samples are taken out at regular intervals, wiped dry, dried under vacuum at 50° C. for overnight and then weighed to determine the weight loss. The degradation studies are undertaken for 60 days under constant conditions.

Three film specimens per sample are subjected to the degradation analysis in the study.

### Advantages of the Invention

Novel UV curable resin formulations based on amino acid like L-glutamic acid, L-aspartic acid which are modified with side chain acrylic units as polymeric crosslinker are provided.
Photocurable resin formulation for 3D printing application and process for its preparation is provided.
3D printed objects prepared using amino acid-based formulation exhibit biodegradability.
Provides acryloyl functionalized amino acid based polymers as crosslinkers in a formulation for 3D printing.
Provides dansyl functionalized amino acid as a light blocker, which enables high resolution to the 3D printed object and at the same time modifies the viscosity of the photocurable formulation thereby functioning as a viscosity modifier as well. Most often the reported 3D printable photocurable formulations use small molecule based dyes as light blockers, which have the disadvantage of probable leaching as they are not chemically bound to the polymer chain.
The application of Dansyl functionalized amino acid polyetster as light blocker in 3D printable resin formulation aids not only to modulate the viscosity, but it is non-leachable unlike small molecule-based dyes that are usually used in photocurable 3D printing formulation for light blocking.
Polymer based light blocker also imparts fluorescence to 3D printed objects as they can emit characteristic green light when viewed under hand-held UV lamp.

1. A biodegradable composition for 3D printing comprising:
a) 4.0 to 20 wt. % of an amino acid based aliphatic, photocurable polyester crosslinker(s) polymer of Formula (I) of the total weight of the composition;
b) 77.16 to 94.5 wt. % of a diluent of total weight of the composition, and
c) 1 to 2 wt. % of a photoinitiator of total weight of the composition;
wherein the crosslinker polymer of Formula (I) is represented by: 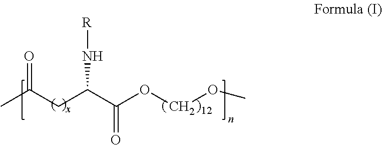
wherein,
X=1 (L-Aspartic acid) or 2 (L-Glutamic acid);
R=Dansyl or Acryloyl; and
n=12 to 15.

2. The biodegradable composition as claimed in claim 1, wherein the crosslinker polymer is selected from acryloyl functionalized L-Glutamic acid and/or L-Aspartic acid based aliphatic, photocurable polyester or Dansyl functionalized L-Glutamic acid and L-Aspartic acid based aliphatic, polyester.

3. The biodegradable composition as claimed in claim 1, wherein the diluent is selected from hydroxyethylmethacrylate (HEMA), hydroxyethyl acrylate (HEA) or mixture thereof.

4. The biodegradable composition as claimed in claim 1, wherein the photoinitiator is diphenyl(2,4,6-trimethyl benzoyl)phosphine oxide or 2-hydroxy-2-methylpropiophenone.

5. The biodegradable composition as claimed in claim 1, further comprises dansyl functionalized glutamic acid based polyester as light absorber, in an amount ranging between 1.34 to 2 wt. % of total weight of composition.

6. The biodegradable composition as claimed in claim 1, wherein amount of hydroxyethylmethacrylate (HEMA) is in a range of 77.16 to 94.5 wt. % of total weight of the composition; amount of the amino acid based aliphatic, photocurable polyester crosslinker polymer is in range of 4.0 to 20 wt. % of total weight of the composition; and amount of diphenyl(2,4,6-trimethyl benzoyl)phosphine oxide is in range of 1 to 2wt % of total weight of the composition.

7. A process for preparation of the biodegradable composition for 3D printing as claimed in claim 1, comprising mixing the diluent, the amino acid based crosslinker and the photoinitiator under sonication for 1 to 1.5 hrs at temperature ranging between 25 to 30° C.

8. The process as claimed in claim 7, wherein ratio of the diluent: the amino acid based crosslinker: the photoinitiator is 0.945:0.04:0.015.
